(19) United States
(12) Patent Application Publication
(10) Pub. No.: US 2015/0047791 A1
(43) Pub. Date: Feb. 19, 2015

(54) WINDOW BLIND ASSEMBLY

(71) Applicants: Shih-Ming Lin, Chiayi City (TW); Chin-Jung Lee, Taichung City (TW)

(72) Inventors: Shih-Ming Lin, Chiayi City (TW); Chin-Jung Lee, Taichung City (TW)

(21) Appl. No.: 14/151,336

(22) Filed: Jan. 9, 2014

(30) Foreign Application Priority Data
Aug. 15, 2013 (TW) 102215347

(51) Int. Cl. E06B 9/384

(52) U.S. Cl. CPC E06B 9/384
USPC 160/84.04

(57) ABSTRACT

A window blind assembly includes a roller unit and a shade unit. The roller unit includes a rotatable shaft, and the shade unit includes a shade body that has a top end connected to the rotatable shaft. The rotatable shaft is rotatable to wind releasably the shade body thereon. The shade body includes a woven layer and an enhancing layer that is bound to the woven layer. The shade body is divided into a plurality of main shade portions and a plurality of folded shade portions. Each of the folded shade portions is stitched via a corresponding thread between a corresponding adjacent pair of the main shade portions.

### CROSS-REFERENCE TO RELATED APPLICATION

This application claims priority of Taiwanese Application No. 102215347, filed on Aug. 15, 2013.

### BACKGROUND OF THE INVENTION

1. Field of the Invention

The invention relates to a window blind, and more particularly to a retractable window blind assembly.

2. Description of the Related Art

There are various styles of window blinds such as roller blind, Roman blind, folding blind, cellular blind and venetian blind, etc. A Roman blind is a pulled-up style with slats and folds that create a layered effect, and its sophisticated and elegant design has always been well received. In contrast, a roller blind includes a blind fabric that is connected to a rod and that can be wound on and unwound from the rod via rotation of one rod, which may be manual or spring driven. The blind fabric of the roller blind is usually a woven fabric made from interlacing yarn or tapes.

However, the blind fabric lacks the layered effect. In addition, the blind fabric requires additional sewing or binding to create selvages for the prevention of fraying. It is also more difficult for end-users to mend the blind fabrics by themselves should alterations be needed after purchase. Furthermore, due to the lack of horizontal reinforcements, the blind fabric tends to warp and become uneven toward the edges. Warped edges result in uneven fabric surface, and also adversely affect the sun shading efficiency.

### SUMMARY OF THE INVENTION

Therefore, the object of the present invention is to provide a window blind assembly that can eliminate the aforesaid drawbacks of the prior art.

According to the present invention, there is provided a window blind assembly including a roller unit and a shade unit. The roller unit includes a rotatable shaft, and the shade unit includes a shade body that has a top end connected to the rotatable shaft. The rotatable shaft is rotatable to wind releasably the shade body thereon. The shade body includes a woven layer and an enhancing layer that is bound to the woven layer. The shade body is divided into a plurality of main shade portions and a plurality of folded shade portions. Each of the folded shade portions is stitched via a thread between an adjacent pair of the main shade portions.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary partly exploded perspective view of the preferred embodiment of a window blind assembly according to the present invention;

FIG. 2 is a fragmentary schematic side view of the preferred embodiment;

FIG. 3 is a fragmentary front view of a shade body of the preferred embodiment; and

FIG. 4 is a sectional view taken along line IV-IV in FIG. 3.

### DETAILED DESCRIPTION OF THE PREFERRED EMBODIMENT

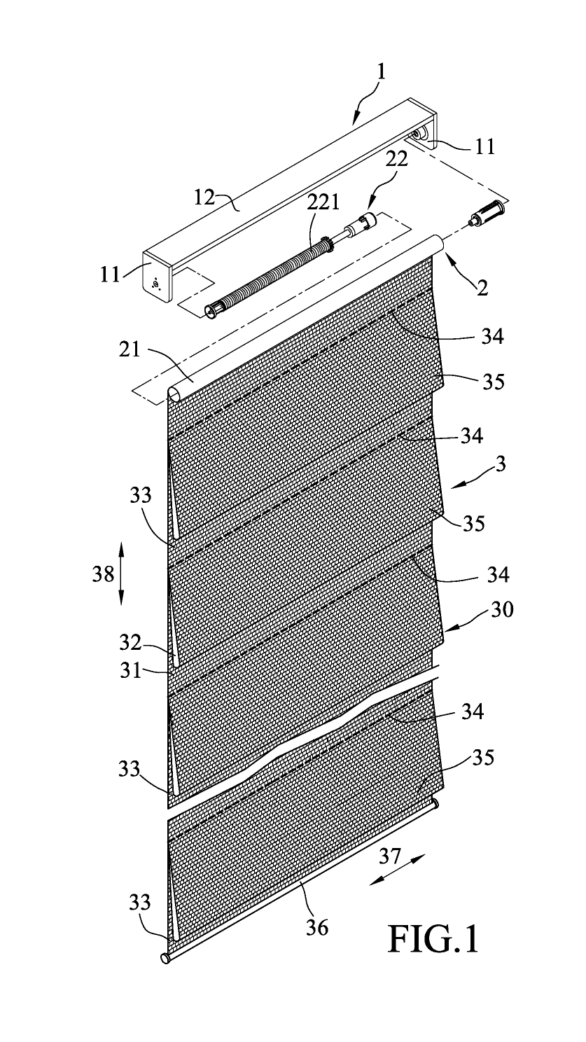

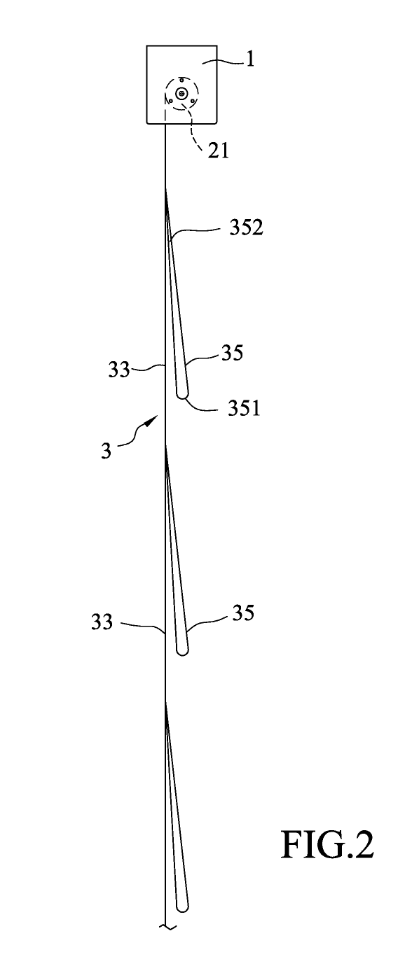

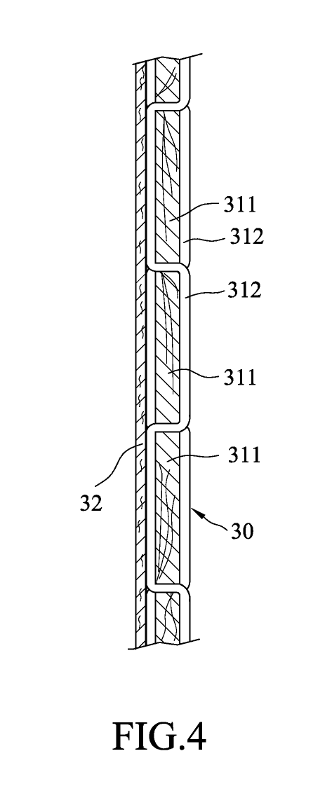

With reference to FIGS. 1, 2, 3 and 4, the preferred embodiment of the window blind assembly according to the present invention includes a seat unit 1, a roller unit 2 disposed in the seat unit 1, a shade unit 3 connected to the roller unit 2.

The seat unit 1 includes two side seats 11 that are opposite to each other in an extending direction 37, and a connecting member 12 that interconnects the side seats 11. The roller unit 2 includes a rotatable shaft 21 extending in the extending direction 37 and connected between the side seats 11 of the seat unit 1, and a retracting member 22 disposed for rotating resiliently the rotatable shaft 21 to retract the shade unit 3. The retracting member 22 is configured as a coil spring 221 retained in the rotatable shaft 21 in this embodiment, but may be configured as a rope or a bead cord being pulled by a user to drive rotation of the rotatable shaft 21. A lock-and-release mechanism may be used for stopping the rotatable shaft 21 at any time. The rotation of the rotatable shaft 21 may even be electrically driven.

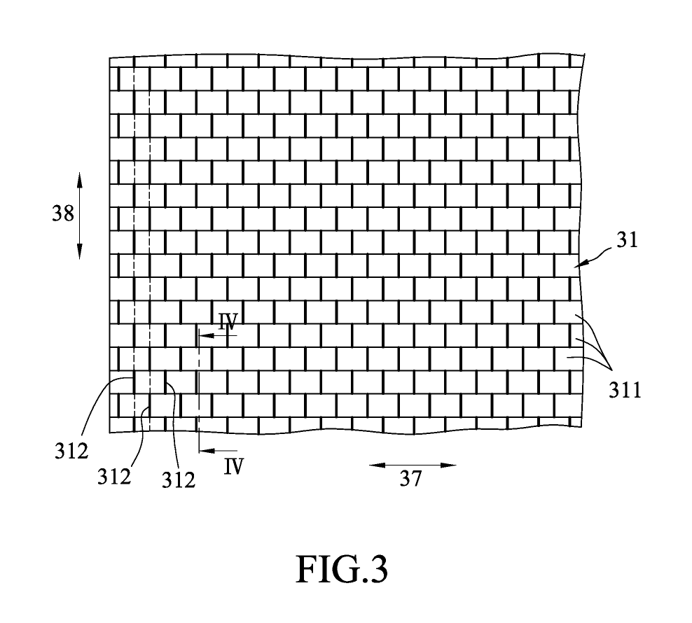

The shade unit 3 includes a shade body 30 that has a top end connected to the rotatable shaft 21, and a bottom rod 36 that is connected to a bottom end of the shade body 30. The shade body 30 includes a woven layer 31 and an enhancing layer 32 that is bound to the woven layer 31. There is no specific limit in the design of the woven layer 31 for the window blind assembly of the present invention. In this embodiment, as shown in FIG. 3, the woven layer 31 has a plurality of parallel tapes 311 extending in the extending direction 37, and a plurality of strings 312 extending in a running direction 38 transverse to the extending direction 37 and interlacing the tapes 311. The weaving of the woven layer 31 may also adopt yarns instead of the tapes 311 and the strings 312, or be interlaced entirely by the tapes 311. In other words, the design of the woven layer 31 is not limited to what is disclosed in this embodiment.

In this embodiment, the enhancing layer 32 is a nonwoven fabric glued to the woven layer 31. However, the enhancing layer 32 may also be a layer of glue coated at the back of the woven layer 31. The woven layer 31 may even be immersed in glue to result in two enhancing layers 32 on opposite sides of the woven layer 31. In other words, the form and the number of the enhancing layer 32 are not limited to what is disclosed in this embodiment.

The shade body 30 is divided into a plurality of main shade portions 33 and a plurality of folded shade portions 35. Each of the folded shade portions 35 has a top end 352 stitched via a corresponding thread 34 between a corresponding adjacent pair of the main shade portions 33, and a free end 351 opposite to the top end 352. In this embodiment, each thread 34 extends in the extending direction 37 through opposite lateral edges of the shade body 30.

With rotation of the rotatable shaft 21, the shade body 30 can be wound releasably on the rotatable shaft 21. When the shade body 30 is unwound as the rotatable shaft 21 is reversely rotated, the folded shade portions 35 would be in front of the main shade portions 33, so that the shade unit 3 displays a roman shade style layered effect.

In addition, by virtue of the enhancing layer 32, the shade body 30 does not fray during the manufacturing process or when being mended by the user after purchase. Therefore, no additional sewing or binding to the shade body 30 is required during alteration or manufacturing.

Furthermore, each thread 34 may serve as reinforcement in the extending direction 37 to prevent warped and uneven edges of the shade body 30.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A window blind assembly comprising:
a roller unit including a rotatable shaft; and
a shade unit including a shade body that has a top end connected to said rotatable shaft, said rotatable shaft being rotatable to wind releasably said shade body thereon, said shade body including a woven layer and an enhancing layer that is bound to said woven layer, and being divided into a plurality of main shade portions, and a plurality of folded shade portions, each of which is stitched via a corresponding thread between a corresponding adjacent pair of said main shade portions.

2. The window blind assembly of claim 1, wherein each of said folded shade portions has a top end stitched between the corresponding adjacent pair of said main shade portions, and a free end opposite to said top end.

3. The window blind assembly of claim 2, wherein said rotatable shaft extends in an extending direction, said thread extending in the extending direction.

4. The window blind assembly of claim 3, wherein said shade unit further includes a bottom rod connected to a bottom end of said shade body.

5. The window blind assembly of claim 1, wherein said rotatable shaft extends in an extending direction, said thread extending in the extending direction.

6. The window blind assembly of claim 1, wherein said woven layer and said enhancing layer are glued together.
